(19) United States
(12) Patent Application Publication
(10) Pub. No.: US 2004/0015601 A1
(43) Pub. Date: Jan. 22, 2004

(54) Method for tracking encapsulated software over a network of computers

(76) Inventor: John C. Whitson, Farmingdale, NY (US)

Correspondence Address: Richard J. McGrath, Esq., BURNS, DOANE, SWECKER & MATHIS, L.L.P., P.O. Box 1404, Alexandria, VA, 22313-1404, US

(21) Appl. No.: 10/196,155

(22) Filed: Jul. 17, 2002

(51) Int. Cl. G06F 15/16

(52) U.S. Cl. 709/235

(57) ABSTRACT

In a method for tracking carrier documents containing an encapsulated software module, a model is created from a directed graph. The nodes of the directed graph include a plurality of computer clusters each having at least one computer, and the arcs of the directed graph represent the transfer paths of carrier documents. The time of day and location of the nodes are used to establish expected traffic values. Expected traffic values are compared to actual traffic values in order to determine inappropriate traffic and to extract transfer paths of interest that may be transferring a carrier document containing an encapsulated software module. Notices regarding the propagation of an undesirable carrier document containing an encapsulated software module are issued, or preventative steps, such as blocking messages from certain nodes and transfer paths, may be implemented to prevent further dissemination of the undesirable carrier documents. The method also permits extrapolations and models of future threats, in order to predict the way carrier documents may be propagated in the future.

### 1. FIELD OF THE INVENTION

The present invention relates to a method for tracking encapsulated software, enclosed in other carrier documents (e.g., electronic mail messages). More specifically, the method tracks software that contains instructions or other software codes that will cause a recipient computer, with or without a user's knowledge, to install and or modify the recipient computer's permanent storage (hard disk, floppy disk or other magnetic or re-writeable persistent media). The present invention utilizes directed graphs to model the transfer paths for transferring the carrier documents.

### 2. BACKGROUND OF THE INVENTION

An example of directed graphs being used to model computer viruses is described in article entitled “Directed-Graph Epidemiological Model of Computer Viruses”, by Jeffery O. Kephart, et al., and published in the Proceedings of the 1991 IEEE Computer Society Symposium on Research in Security and Privacy, Oakland, Calif., May 20-22, 1991; pp. 343-359. This particular article uses directed graphs to predict the spread of computer viruses, but it does not use world wide temporal patterns to predict and simulate distribution patterns of carrier documents that may contain viruses in the form of encapsulated software modules.

It is also well known in the art to use directed graphs to model network traffic and messages as a function of quality of service, documentation and design, but these prior art uses do not include temporal attributes. Influence diagrams are well known as methods of probabilistic reasoning. Such influence diagrams, however, model static (unchanging) systems and cannot reflect the dynamics of the present invention.

### SUMMARY OF THE INVENTION

The present invention relates to a method for tracking carrier documents containing an encapsulated software module. In order to the track the undesirable carrier documents a model is created from a directed graph. The nodes of the directed graph include a plurality of computer clusters each having at least one computer, and the arcs of the directed graph represent the transfer paths of carrier documents. The time of day and location of the nodes are used to establish expected traffic values. Expected traffic values are compared to actual traffic values in order to determine inappropriate traffic and to extract transfer paths of interest that may be transferring an undesirable carrier document containing an encapsulated software module. A notice is issued when it is likely that an undesirable carrier document containing an encapsulated software module is to be propagated to a node along a transfer path of interest. Preventative steps, such as blocking messages from certain nodes and transfer paths, may be implemented to prevent further dissemination of the undesirable carrier documents containing encapsulated software modules.

### BRIEF DESCRIPTION OF THE DRAWINGS

FIG. 1 is a directed graph of two clusters of computers in different time zones;

FIG. 2 is a diagram depicting the propagation of a malicious or undesirable carrier document;

FIG. 3 is an illustration of an electronic mail message containing an encapsulated software module; and

FIGS. 4a and 4b are flow charts depicting the method of the present invention.

### DETAILED DESCRIPTION OF THE INVENTION

The present invention is directed to tracking encapsulated software in other documents such as electronic mail messages often referred to as e-mail. The actual function of the installed encapsulated code is not relevant to the present invention. Through the use of directed graph representations of the interconnections between computers, a message routing scheme may be derived and used to track the past paths of the encapsulated software, and by extrapolation, the graph may be used to predict the continuing propagation of this encapsulated code.

In order to better understand the present invention, several definitions are provided below. The below listed definitions are intended to more accurately and conveniently describe the present invention. To the extent that terms below are defined more narrowly, broadly, inconsistently or differently from the terms and definitions used by others, the terms and definitions listed below are intended to be controlling when construing the scope of the present invention.

Carrier Document—any document that contains an encapsulated software module, or any document that contains a complete software module or fragment of a software module. Examples of carrier documents include electronic mail messages, electronic data files and application software. The presence of an encapsulated software module need not be obvious or visible in a carrier document.

Directed Graph—a data structure consisting of nodes and arcs that connect the nodes. In a directed graph, the arcs are unidirectional, pointing away or towards a node only, with unique properties assigned to each arc.

Encapsulated Software Module (ESM)—a self-contained piece of data that when invoked causes software to be run on a node. Examples include macros, scripts, virus, application files that include macros, scripts and viruses, as well as provocative web sites that directly or indirectly reference other modules. An ESM can also be a module or document that contains instructions or other codes which direct a computer to function in a particular fashion. Examples of Encapsulated Software Modules include “Macro Viruses” that are contained in Microsoft Word documents, script files and applications contained in electronic mail messages as “enclosures” or “attachments”, and script files that are embedded or referenced in HyperText Markup Language (HTML) World Wide Web (WWW) documents.

Event ¥ an arrival or departure of a message at a node, or invocation of an executable message on a node.

Link ¥ a directional connection between two nodes that communicate by passing messages.

Message ¥ a single electronic document comprised of one or more carrier documents and/or encapsulated software modules. Messages are tracked by monitoring systems at the origin node, relay nodes, and the destination node.

Model ¥ a mathematical machine-manipulated structure that reflects the presence and properties of links between nodes, node clusters and transfer paths.

Node—a network entity. It could be a PC, workstation, server, or networking appliance.

Node cluster ¥ a group of nodes that share close geographical proximity. As a minimum, all nodes in a node cluster should share the same time zone.

Transfer Path—a series of links between two nodes or node clusters, or a directed route that a carrier document follows when transmitted between computers or computer clusters. Each transfer path maps one-to-one to the arcs in the directed graph.

The method of the present invention is useful for the tracking, and prediction of the propagation of encapsulated software modules (ESM) among a network of computers. ESM are of interest to a number of parties, especially in the document tracking and control application area and the computer virus protection application area. While the present invention is well adapted for use in the virus protection application area, the present invention is not limited to malicious code only. The present invention can be applied to publicly available (or pirated) applications whose presence are of interest to the end user. Software patch control, software license enforcement, virus propagation and protection, and application inventory are all applicable products that can use the method of the present invention.

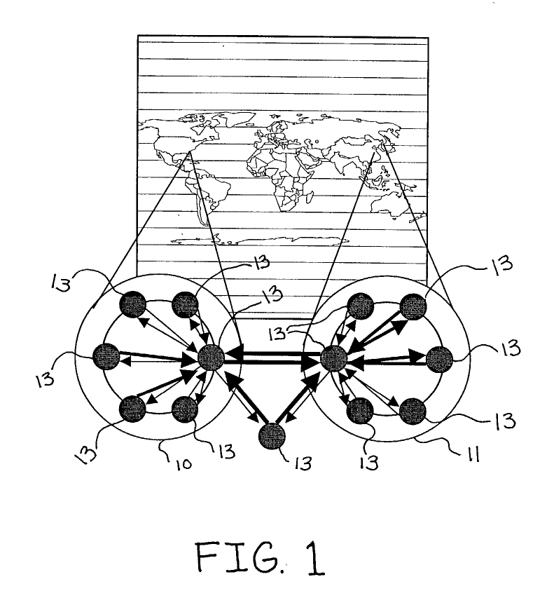

Referring now to FIG. 1, a directed graph depicts two clusters (ovals) of computers 10, 11 in different time zones. The cluster of computers 10 is located in the Eastern Standard Time zone of the United States, and the cluster of computers 11 is located in a different time zone in Asia. Each cluster of computers 10, 11 is comprised of nodes. The darker arc between the nodes indicates more frequently used linkages when propagating carrier documents. The temporal relationships are encoded through the knowledge of the relative time zone differences between the two clusters and the work habits encoded through the knowledge of the relative time zone differences between the two clusters and the work habits of the involved user, as derived from observable statistics.

In other words, the computer clusters 10, 11 represent two distant locales, each of which has been characterized in terms of the transfer paths (arcs) of the carrier documents. Darker arcs here pictorially denote more frequently used paths. Assigned to each path are a number of attributes that characterize the transfer properties of that path and the time of day at the source and destination. The times of day are used to establish temporal resonance, in which active time periods at a cluster are more likely to incur new acts of transfer for a given carrier document, and time periods that are inactive will reduce the chances of new propagation of the given carrier document. This provides the carrier document tracking capability

Additionally, by extrapolating in advance of real time according to the temporal transfer path relationships between C, computers, probabilistic destinations and arrival schedules can be made with greatly increased accuracy over the current practice. This result of predicting the propagation of carrier documents is important and represents an innovative capability.

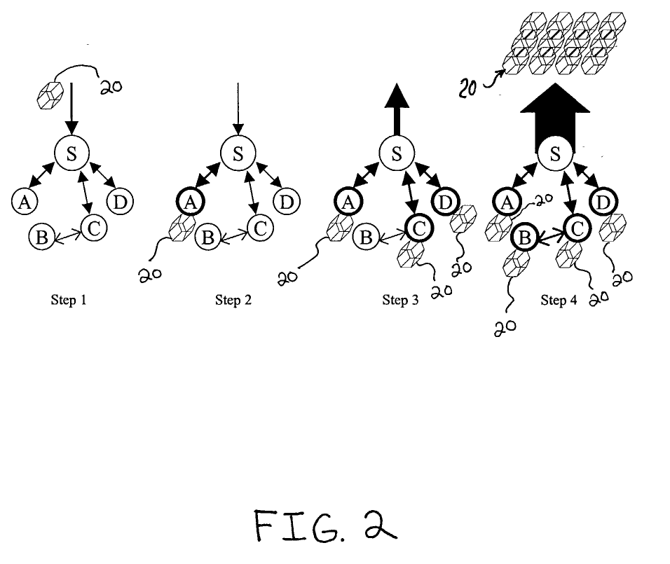

The detailed propagation of a carrier document is depicted in the diagram of FIG. 2, Propagation of a malicious carrier document (hexahedron) 20 from initial introduction to complete distribution. Step 1 illustrates the arrival of the carrier document 20 at a central mail service S. Step 2 takes place when the user of computer A reads an electronic mail document, thus activating the malicious encapsulated document or virus, and forcing propagation to its frequent peers B, C, D on the server S. Step 3 takes place when users on computer C and D read their electronic messages, thus spreading the document further. Step 4 shows full contamination or distribution, each of the machines A, C and D initiating large fan-out volumes of the carrier document. It should be noted that even computer B which did not participate in the interaction with server S still was infected by virtue of a network disk or other transfer mechanism.

These relationships between A, B, C, D, and S (and their remote counterparts) are exploited with augmented attribute data, especially the source, destination, and date of the carrier documents (whenever available) during the active propagation through a LAN. Equally applicable is the assignment of probabilistic estimates based upon the frequency of use of particular paths on WAN and the Internet as well as the likely propagation initiation time at a computer. Due to the nature of this kind of propagation, most time-dependent incidents rely on user action (i.e. opening an electronic mail message) and hence can be tied to habitual work schedules based on location and time zone. In support of these attributes, especially for electronic mail propagation an example electronic mail message is listed below which supplies much of the needed criteria.

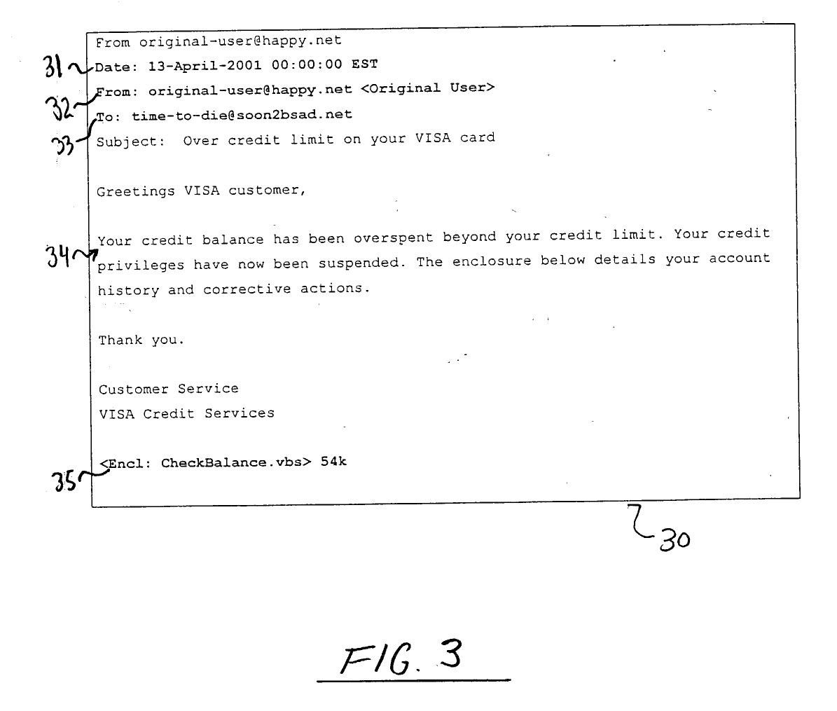

Referring now to FIG. 3, an illustration of an example electronic mail message 30 is provided. The electronic mail message 30 illustrates required fields as well as a provocative message 34 that would cause a user to open (run) the specified enclosure 35, which in this case is a Microsoft Visual Basic™ program script.

There are additional headers in the text of many such messages that can be exploited to determine origin, source, time zone, and more but they are not necessarily present, especially inside a local network. The “Date” field 31 supplies the sending date and time zone. The “From” field 32 identifies the origin, which has been easy to spoof but is now more difficult in a client-server implementation of today. The “To” field 33 specifies the recipient. The properties of the enclosure (name, size, etc) also add attributes to the propagation of such carrier documents. These fields, along, with the historical frequency of use provide the discriminating input to this method.

Much of the discussion regarding the present invention has been oriented towards viruses and malicious code. The method, however, is equally applicable to the propagation of special documents that users knowingly propagate. Tracking of these non-viral documents is no different from the viral documents. The difference is in whether they constitute a threat to the organization. Viral documents are definitely a threat. Examples of non-viral documents that could be threatening include classified documents on unclassified networks, proprietary information such as copyrighted material including digital audio and video files, illegal software and shareware downloads, untrained or unauthorized users, results of network attacks (password files), jokes or inappropriate content, and obscene or pornographic imagery. The present invention, therefore, is independent of the intent of the encapsulated software module.

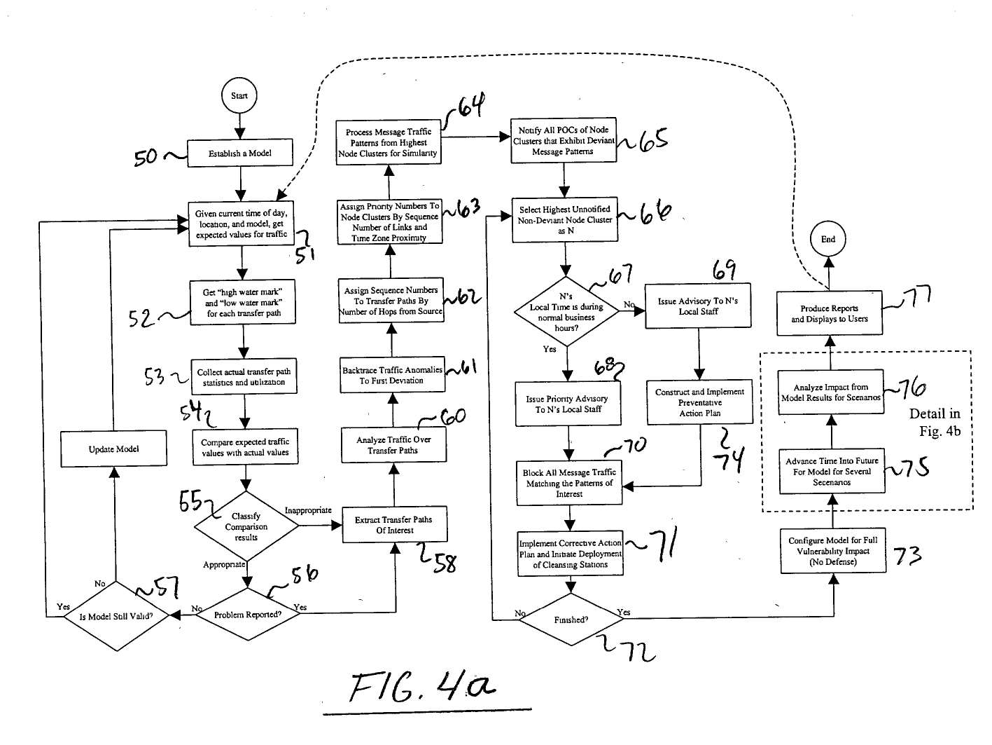

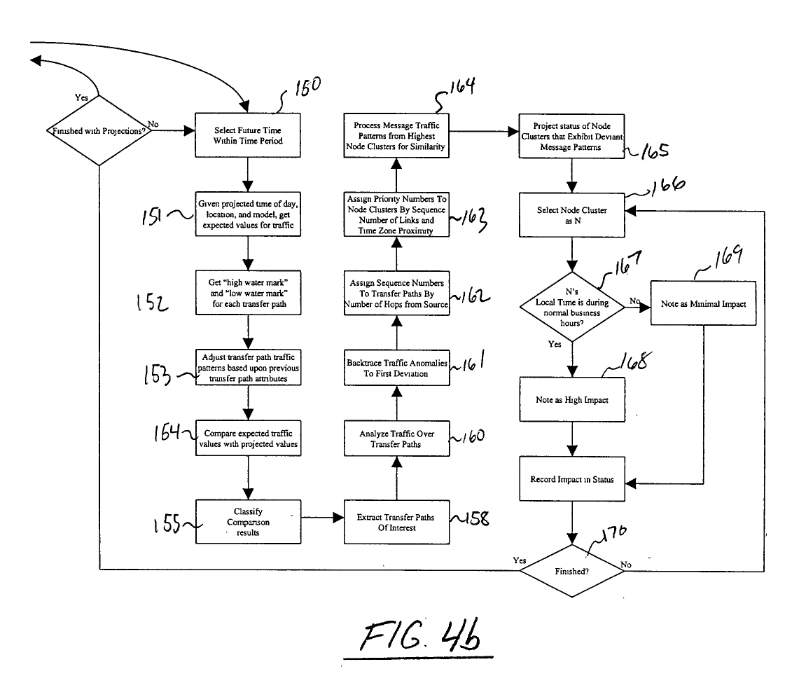

A more detailed description of the software used to implement the present invention is provided in the flowcharts of FIGS. 4a and 4b. The first step 50 of the present invention is to establish a model of a mathematical machine-manipulated structure that reflects the presence and properties of links between nodes, node clusters and transfer paths. In step 51, the model, the current time of day, and the location are used to determine the expected values for traffic. In step 52, the “high water mark” and “low water mark” for each transfer path is determined. A transfer path is a series of links between two nodes or node clusters, or a directed route that a carrier document follows when transmitted between computers or computer clusters. In step 53, the actual statistics and utilization for each transfer path is collected. In step 54, the expected traffic values are compared with the actual values.

The comparison of the expected traffic values and actual traffic values are classified in step 55, and if the comparison is appropriate, then a determination is made in step 56 whether a problem has been reported. If the no problem has been reported, then a determination is made in step 57 whether the model is still valid. If the model is not valid, then the model is updated for future use and the tracking continues by returning to step 51. If the model is still valid, then the tracking continues by returning directly to step 51.

If there is a determination in step 55 that the comparison of the expected traffic values and actual traffic values is inappropriate, the transfer path of interest is extracted in step 58. In step 60, an analysis of the traffic over the traffic path of interest is performed. In step 61, a back tracing of the anomalies to the first anomaly is made. In step 62, sequence numbers are assigned to transfer paths by the number of hops from the source, and in step 63, priority numbers are assigned to node clusters 10, 11 by the sequence number of links and time zone proximity. The message traffic patterns from the node clusters with highest priority numbers are then processed for similarity in step 64. All points of contact (POC's) of node clusters that exhibit deviant message patterns are notified in step 65.

In step 66, the highest non-deviant node cluster is selected and designated as N. A determination is then made in step 67, whether the local time of node cluster N is during normal business hours. If it is determined that the local time at node cluster N is not within normal business hours, then a priority advisory is issued to the local staff of node cluster N in step 69. A preventative action plan is constructed and issued in step 74, and all message traffic matching the pattern of interest is blocked in step 70.

If it is determined that the local time at node cluster N is within normal business hours, then a priority advisory is also issued to the local staff of node cluster N in step 68. In step 70, all message traffic that matches the pattern of interest is blocked. In step 71, a corrective action plan is implemented, and the deployment of cleansing stations is initiated. Once the corrective action is implemented for node cluster N, a determination is made in step 72 whether other node clusters require corrective active. If other node clusters require corrective action, the process returns to step 66. If other node clusters do not require corrective action, then the model should be configured in step 73 for full vulnerability impact which essentially means that there is no present defense to the problem. In order to provide a future defense to the problem, a projection must be implemented using steps 75 and 76. The method requires in step 75 that a future time be selected within a desired time period, and models of various scenarios be created. These models and scenarios are analyzed in step 76 in order to determine their possible impacts. In step 77, the future models can be used to produce reports and to display data to users. The future models can also be used to update the existing models of step 51.

Referring now to FIG. 4b, a flow chart depicts the process for implementing a defense based upon various future models and scenarios. Many of the steps described above and utilized in the evaluation of existing models is useful for evaluating future models.

The first step in evaluating future models is the step 150 of actually selecting a future time within a desired time period. In step 151, the projected time of day, model and the location are assigned expected values for traffic. In step 152, the “high water mark” and “low water mark” for each transfer path is determined. In step 153, transfer path patterns are adjusted based upon previous transfer path attributes. In step 154, the expected traffic values are compared with the projected values.

The comparison of the expected traffic values and the projected traffic values are classified in step 155. If there is a determination in step 155 that the comparisons of the expected traffic values and projected traffic values are inappropriate, transfer paths of interest are extracted in step 158. In step 160, an analysis of the traffic over the traffic path of interest is performed. In step 161, a back tracing of the anomalies to the first anomaly is made. In step 162, sequence numbers are assigned to transfer paths by the number of hops from the source, and in step 163, priority numbers are assigned to node clusters by the sequence number of links and time zone proximity. The message traffic patterns from the node clusters with highest priority numbers are then processed for similarity in step 164.

Based upon this processing, a projected status of node clusters that exhibit deviant message pattern is derived in step 165. In step 166, a node cluster is selected and designated as N. A determination is then made in step 167, whether the local time of node cluster N is during normal business hours. If it is determined that the local time at node cluster N is not within normal business hours, then the impact of the message is noted as being of minimal impact in step 169. If it is determined that the local time at node cluster N is within normal business hours, then the impact of the message is noted as being of high impact in step 169. In step 170, an intermediate determination is made, and in step 171 there is a final determination whether the projected modeling is finished. Once the projections are completely finished in step 171, the results are used in step 77 to produce reports and to display data to users.

While the present invention has been described with respect to certain exemplary embodiments, one skilled in the art will appreciate that the invention would equally apply to other such systems. Many variants and combinations of the techniques taught above may be devised by a person skilled in the art without departing from the spirit or scope of the invention as described by the following claims.

I claim:

1. A method for tracking carrier documents containing an encapsulated software module, comprising the steps of:
creating a model from a directed graph, in which nodes of the directed graph include a plurality of computer clusters each having at least one computer, and arcs of the directed graph representing the transfer paths of carrier documents;
utilizing at least the time of day and location of a plurality of nodes to establish expected traffic values;
comparing expected traffic values to actual traffic values in order to determine inappropriate traffic and to extract transfer paths of interest that may be transferring an carrier document containing an encapsulated software module; and
issuing a notice when it is likely that the carrier document containing an encapsulated software module is being propagated.

2. A method according to claim 1 which further includes the step of extrapolating by statistical means the future paths of the carrier document destinations.

3. A method according to claim 1 wherein the utilizing step further includes properties of the encapsulated software module.

4. A method according to claim 3 wherein the properties include the name, size and historical frequency of use of the encapsulated software module.

5. A method according to claim 2 which further includes the step of blocking carrier documents, after being issued a notice that is likely that undesirable carrier documents are being propagated.

6. A method according to claim 5 which further includes the step of cleansing any undesirable carrier documents that have been received.

7. A method according to claim 1 wherein the undesirable carrier document is an electronic mail message and the encapsulated software module is a computer virus.

8. A method according to claim 1 wherein the encapsulated software module includes data protected by proprietary rights.

9. A method according to claim 1 wherein the encapsulated software module includes a digital audio file.

10. A method according to claim 1 wherein the encapsulated software module includes a digital video file.

11. A method according to claim 1 wherein the encapsulated software module includes offensive material.

12. A method according to claim 1 wherein the carrier document includes a provocative message.
